(19) United States
(12) Patent Application Publication
(10) Pub. No.: US 2014/0193725 A1
(43) Pub. Date: Jul. 10, 2014

(54) Fuel Cell System Having Water Vapor Condensation Protection

(71) Applicant: LILLIPUTIAN SYSTEMS, INC., Wilmington, MA (US)

(72) Inventors: Samuel B. Schaevitz, Concord, MA (US); Alan P. Ludwiszewski, Andover, MA (US); Albert D. Michael, Auburndale, MA (US)

(73) Assignee: LILLIPUTIAN SYSTEMS, INC., Wilmington, MA (US)

(21) Appl. No.: 13/734,854

(22) Filed: Jan. 4, 2013

(51) Int. Cl. H01M 8/04

(52) U.S. Cl. CPC H01M 8/04119; H01M 8/04164
USPC 429/414; 429/413

(57) ABSTRACT

A fuel cell system having protection from water vapor condensation is disclosed. The system includes a fuel cell having an input port configured to receive an input gas and a liquid water transient accumulation chamber coupled to the input port. The chamber is configured to accumulate condensed water vapor from the input gas. The chamber includes a water-capture element configured to retain liquid water therein. The system further includes a first thermal pathway coupled to the chamber and also coupled to the fuel cell, so that the chamber is heated by heat from the fuel cell, when the fuel cell is operating in a steady state, in a manner that causes the liquid water accumulated in the chamber to be evaporated by the heat.

### CROSS REFERENCE TO RELATED APPLICATIONS

The present application is related to U.S. patent application entitled FUEL CELL SYSTEMS AND RELATED METHODS, Attorney Docket No. 3553/138, filed on Jan. 4, 2013, U.S. patent application entitled A FUEL CELL SYSTEM HAVING AN AIR QUALITY SENSOR SUITE, Attorney Docket No. 3553/139, filed on Jan. 4, 2013, U.S. patent application entitled FUEL CELL SYSTEM HAVING A PUMP AND RELATED METHOD, Attorney Docket No. 3553/141, filed on Jan. 4, 2013, U.S. patent application entitled A FUEL CELL SYSTEM HAVING A SAFETY MODE, Attorney Docket No. 3553/143, filed on Jan. 4, 2013, U.S. patent application entitled A PORTABLE FUEL CELL SYSTEM HAVING A FUEL CELL SYSTEM CONTROLLER, Attorney Docket No. 3553/144, filed on Jan. 4, 2013, U.S. patent application entitled A METHOD FOR BONDING SUBSTRATES, Attorney Docket No. 3553/145, filed on Jan. 4, 2013, and U.S. patent application entitled LOW VIBRATION LINEAR MOTOR SYSTEMS, Attorney Docket No. 3553/146, filed on Jan. 4, 2013, the disclosures of which are incorporated by reference herein in their entirety.

### TECHNICAL FIELD

The present invention relates generally to a portable fuel cell system, and more particularly to a portable fuel cell system having protection from water vapor condensation.

### BACKGROUND ART

Fuel cells produce electricity from chemical reactions. The chemical reactions typically cause a fuel, such as hydrogen, to react with air/oxygen as reactants to produce water vapor as a primary by-product. The hydrogen can be provided directly, in the form of hydrogen gas or liquid, or can be produced from other materials, such as hydrocarbon liquids or gases. Fuel cell assemblies may include one or more fuel cells in a fuel cell housing that is coupled with a fuel canister containing the hydrogen and/or hydrocarbons. Fuel cell housings that are portable coupled with fuel canisters that are portable, replaceable, and/or refillable, compete with batteries as a preferred electricity source to power a wide array of portable consumer electronics products, such as cell phones and personal digital assistants. The competitiveness of these fuel cell assemblies when compared to batteries depends on a number of factors, including their size, cost, efficiency, and reliability.

A high temperature Solid Oxide Fuel Cell (SOFC) is a promising approach to implementing a portable fuel cell. SOFC are composed of an electrolyte of ion-conductive solid oxide such as stabilized zirconia. On one side of the electrolyte is the cathode, supplied by an oxidizing chemical, typically air. On the other side of the electrolyte is the anode, supplied by a fuel to be oxidized, often hydrogen or a hydrocarbon, typically in gaseous form.

In a fuel cell of this type, it is often necessary to remove impurities from the oxidizer and fuel to prevent damage to the fuel cell. Particulates can be removed by the use of filters. However, in small SOFC there is another contamination danger from liquid water if it condenses in the fuel or oxidizer lines when they are cold during the startup phase of the fuel cell. This water can come from the humidity of ambient air or from a partial recirculation of humidified exhaust gas. If liquid water is transported into the heated region, rapid and destructive boiling can occur.

Some systems intended for outdoor operation are designed to remove all water from the system before the system is shut down. This is especially important when the system is exposed to temperatures below the freezing point of water, since any moisture in the system can form ice and damage critical components. However, these systems are generally large permanent installations or part of a vehicle system that will not be damaged by small amounts of liquid water during operation.

Therefore, there is a need to provide a portable fuel cell system that will incorporate features for effectively protecting the system from water vapor condensation, especially during startup and other transient condensation conditions.

### SUMMARY OF THE EMBODIMENTS

In accordance with one embodiment of the invention, a fuel cell system having protection from water vapor condensation includes a fuel cell having an input port configured to receive an input gas and a liquid water transient accumulation chamber coupled to the input port. The chamber is configured to accumulate condensed water vapor from the input gas. The chamber includes a water-capture element configured to retain liquid water therein. The system further includes a first thermal pathway coupled to the chamber and also coupled to the fuel cell, so that the chamber is heated by heat from the fuel cell, when the fuel cell is operating in a steady state, in a manner that causes the liquid water accumulated in the chamber to be evaporated by the heat.

In related embodiments, the fuel cell may be configured for use above 100 degrees Celsius. The fuel cell may further include an exhaust port configured to provide an exhaust gas flow, and the system may further include a recirculation conduit having a first end coupled to the exhaust port and a second end coupled to the liquid water transient accumulation chamber, wherein the recirculation conduit is configured to pass a first portion of the exhaust gas to the fuel cell input port, and the liquid water transient accumulation chamber is configured to condense water vapor from the first portion of the exhaust gas. The system may further include a pump configured to pump gas through the fuel cell, a temperature sensor, and a fuel cell system controller coupled to the pump and the temperature sensor, wherein the fuel cell system controller is configured to prevent operation of the pump when the temperature sensor is below a minimum temperature threshold. The system may further include a humidity sensor coupled to the fuel cell system controller and configured to provide a humidity sensor signal to the fuel cell system controller, wherein the minimum temperature threshold is based on the humidity sensor signal. The system may further include a heater coupled to the fuel cell system controller, wherein the fuel cell system controller is further configured to cause the heater to supply heat when the temperature sensor is below the minimum temperature threshold. The system may further include a pump configured to pump gas through the fuel cell, and a second thermal pathway in thermal communication with the pump and in thermal communication with the fuel cell.

In further related embodiments, the fuel cell may further include an exhaust port configured to provide an exhaust gas flow, and the system may further include a muffler having a muffler inlet and a muffler pressure restriction element, an exhaust conduit having a first end coupled to the exhaust port and a second end coupled to the muffler inlet, and a second thermal pathway in thermal communication with the fuel cell and in thermal communication with the muffler pressure restriction element. The fuel cell may further include an exhaust port configured to provide an exhaust gas flow, and the system may further include an exhaust conduit having a first end coupled to the exhaust port and a second end coupled to ambient environment, and a second thermal pathway in thermal communication with the fuel cell and in thermal communication with the exhaust conduit configured so that substantially all of the exhaust conduit is above 45 degrees Celsius during steady state operation of the fuel cell system. The system may further include a fan configured to move ambient air across the second end of the exhaust conduit. The system may further include a heat sink thermally coupled to the fuel cell, a fan configured to move ambient air over the heat sink, a temperature sensor, and a fuel cell system controller coupled to the fan and the temperature sensor, wherein the fuel cell system controller is configured to prevent operation of the fan when the temperature sensor is below a minimum temperature threshold. The system may further include a heat sink thermally coupled to the fuel cell, a fan configured to move ambient air over the heat sink at a fan flow rate, a temperature sensor, and a fuel cell system controller coupled to the fan and the temperature sensor, wherein the fuel cell system controller is configured to modulate the fan flow rate to maintain a target temperature. The system may further include a pump configured to pump gas through the chamber, a fuel cell system controller operationally coupled to the pump and configured to control operation of the pump, and a fuel flow controller coupled to the fuel cell system controller, the fuel flow controller configured to stop flow of fuel to the fuel cell, wherein the fuel cell system controller is further configured to cause the pump to continue pumping after the fuel flow controller has stopped the flow of fuel. The fuel cell may be a solid oxide fuel cell. The system may further include an input conduit with a first end coupled to the liquid water transient accumulation chamber and a second end coupled to the input port, the input conduit having a hydrophobic segment, the hydrophobic segment having a hydrophobic coating.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram illustrating a portable fuel cell system having fuel cell protection from liquid in accordance with embodiments of the present invention.

FIG. 2 is a schematic diagram illustrating a portable fuel cell system with a hydrophobic segment in an input conduit in accordance with embodiments of the present invention.

FIG. 3 is a schematic diagram illustrating a portable fuel cell system with a recirculation conduit in accordance with embodiments of the present invention.

FIG. 4 is a schematic diagram illustrating a portable fuel cell system with a pump and a fuel cell system controller in accordance with embodiments of the present invention.

FIG. 5 is a schematic diagram illustrating a portable fuel cell system with a pump and a second thermal pathway in accordance with embodiments of the present invention.

FIG. 6 is a schematic diagram illustrating a portable fuel cell system with a muffler in accordance with embodiments of the present invention.

FIG. 7 is a schematic diagram illustrating a portable fuel cell system with an exhaust conduit and a fan in accordance with embodiments of the present invention.

FIG. 8 is a schematic diagram illustrating a portable fuel cell system with a fuel cell system controller and a heat sink in accordance with embodiments of the present invention.

FIG. 9 is a schematic diagram illustrating a portable fuel cell system with a fuel cell system controller and a fuel flow controller in accordance with embodiments of the present invention.

### DETAILED DESCRIPTION OF SPECIFIC EMBODIMENTS

Definitions. As used in this description and the accompanying claims, the following terms shall have the meanings indicated, unless the context otherwise requires:

A “fuel cell” is any portion of the system containing at least part of the electrochemical conversion structures, including an anode, electrolyte and cathode, and also including portions of the housings and flow conduits coupled to the electrochemical structures.

An “anode gas” is the gas which is supplied to the anode side (negative side) of the fuel cell.

A “cathode gas” is the gas which is supplied to the cathode side (positive side) of the fuel cell.

An “exhaust gas” is the gas given off by at least one of the anode or cathode portions of the fuel cell, which transports the fuel cell chemical reaction products out of the anode and cathode sides.

An “anode port” is the inlet to the fuel cell that allows the anode gas to flow into the anode side.

A “cathode port” is the inlet to the fuel cell that allows the cathode gas to flow into the cathode side.

An “exhaust port” is the outlet from the fuel cell that allows chemical reaction products to flow out of at least one of the anode and cathode portions of the fuel cell. There may be one exhaust port for each of the anode and cathode, or there may be a combined port.

A “chamber” is a volume added to a fluidic conduit.

A “water-capture element” in a chamber means a mechanism in the chamber that includes a hydrophobic material, a hydrophilic material, or a physical arrangement that tends to constrain liquid water from leaving the chamber.

A “fuel cell heater” is an electrical component that uses electrical power to create heat heating the fuel cell above the ambient temperature.

A “thermal pathway” is a component or construction of the system which encourages heat transfer between objects, for example heat transfer may be accomplished by direct physical contact, coupling with a thermally conductive body, and/or conductive and radiative transfer due to proximity.

A “thermal pathway from the fuel cell” is a thermal pathway which allows a flow of heat from the fuel cell.

A “pump” is a general term to describe any component which provides motive force to a flow. Example components would be a diaphragm pump, an axial blower, and/or a rotary vane pump.

A “fan” is a general term interchangeable with “pump”.

A “muffler” refers to a component in a fluidic conduit between the system and the ambient environment used to dampen noise generated by the pump.

A “heat sink” refers to a component that connects a thermal pathway to the ambient environment.

A “humidity sensor” measures the water vapor content of a gas.

“Steady-state operation” is the condition when the fuel cell and all subcomponents have reached approximately their targeted operating temperature and are maintaining this temperature.

“System startup” is the operating state or states between when the system transitions out of an off, idle, or otherwise reduced operating mode and when the system has reached steady-state operation.

“Shut down” is the operating state or states between when the system transitions out of steady-state operation and when it is producing power and heat below 10% of steady state values.

Fuel cells operating in a consumer's possession are subject to unpredictable operating environments. It is desirable to be able to operate the fuel cell system under a wide range of conditions without harm to the system. In particular, for small high temperature fuel cells, liquid water must never enter the fuel cell. This is true despite operation in environments with significant variation in humidity level, and temperatures, as well as a possible enclosed space causing unexpected recirculation of humidified exhaust gas from the system.

Various embodiments herein provide a fuel cell system and related method that protect against damage from liquid water formed transiently during startup, and thereby result in a system which is more reliable than prior art systems.

One possible scenario in regard to which a portable fuel cell system can be exposed to the risk of water condensation is when the system is initially kept in a cold location, for example during a winter day outside, and then transported to a warmer location with a relatively high humidity, such as an office building or a restaurant. Under such a transition, the likelihood of water condensation inside the fuel cell system is high. This scenario is undesirable because the fuel cell, operating above the boiling point of water, may experience explosive boiling when liquid water is transported into a heated region, which could result in significant mechanical damage to the system. In accordance with embodiments of the present invention, the utilization of a liquid water accumulation chamber allows the condensed water to become trapped in a location that functions as a barrier to water entry into the fuel cell. However, if the liquid water accumulation chamber is not thermally coupled to the fuel cell, repeated exposure of the fuel system to the temperature fluctuation conditions described above could result in overflowing the chamber and, consequently, damaging the fuel cell. By thermally coupling the water accumulation chamber to the fuel cell, the accumulated water can be evaporated during steady state operation, which provides for safe and reliable operation of the fuel cell system. This configuration and other related embodiments are described in detail below.

To ensure that water which condenses in the water accumulation chamber does not immediately move out of the chamber into the fuel cell, embodiments of the present invention may include a water-capture element in the water accumulation chamber. A wide variety of materials and geometric constructions may be used for the water capture element, as known by those skilled in the art. For example, the three most common configurations are hydrophilic porous materials, hydrophobic porous materials and/or tortuous geometries.

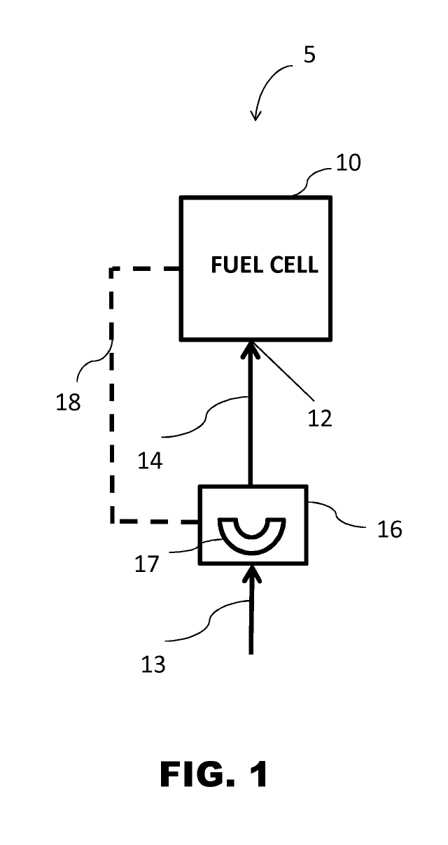

According to embodiments of the present invention, as illustrated in FIG. 1, portable fuel cell system 5 having fuel cell protection from liquid includes fuel cell 10 having input port 12 configured to receive an input gas and liquid water transient accumulation chamber 16, coupled to the fuel cell input port 12 and configured to accumulate condensed water vapor from the input gas (e.g., during cold startup). The chamber 16 includes water-capture element 17 configured to retain liquid water therein. The system 5 may further include a chamber input conduit 13 that allows gas to flow into the chamber 16 through the chamber input conduit 13. The fuel cell system 5 further includes a first thermal pathway 18 coupled to the chamber 16 and also coupled to the fuel cell 10, so that the chamber 16 is heated by heat from the fuel cell 10, when the fuel cell 10 is operating in a steady state, in a manner that causes the liquid water accumulated in the chamber 16 to be evaporated by the heat. By thermally coupling the water accumulation chamber 16 to the fuel cell 10, the accumulated water can be evaporated during steady state operation, which prevents water overflow and hence provides for safe and reliable operation of the fuel cell system 5.

The water-capture element 17 is a mechanism in the chamber 16 that may include a hydrophobic material, a hydrophilic material, and/or a physical arrangement that tends to constrain liquid water from leaving the chamber, independent of the geometric ordination of the fuel cell system 5 or water-capture element 17. For example, as mentioned above, the water-capture element 17 may include hydrophilic porous materials, which capture water by simple absorption, much like a sponge, and therefore prevent the water from moving freely. The water-capture element 17 may include hydrophobic porous materials, which capture water in a number of different ways. For example, one capture mechanism is forming small, separated droplets in the interior of the material. The droplets are prevented from coalescing and escaping by the repulsion with the hydrophobic surfaces. The water-capture element 17 may include specific geometries, such as tortuous or maze-like geometries, which capture water by minimizing the probability of liquid reaching the exhaust. For example, water droplets may freely move about in an accumulation region, but the droplets will be unlikely to flow out of the exit. In some embodiments, the fuel cell 10 may be configured for use above 100 degrees Celsius. In some embodiments, the fuel cell 10 can be a solid oxide fuel cell.

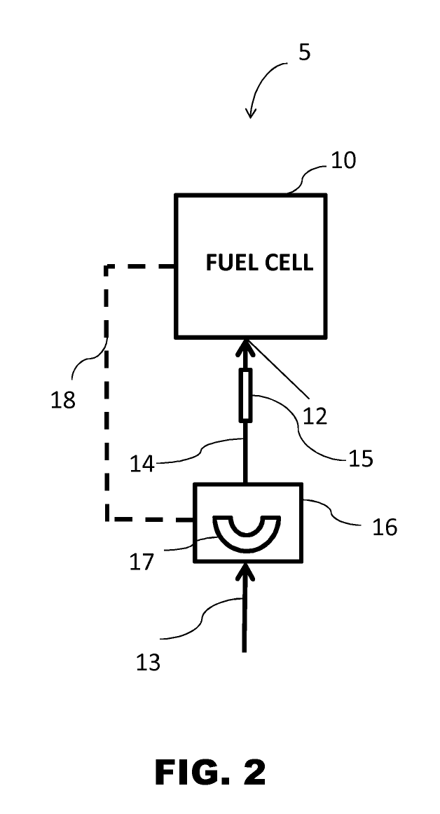

According to some embodiments of the present invention, the fuel cell system 5 may include an input conduit 14 having a first end coupled to the liquid water transient accumulation chamber 16 and a second end coupled to the input port 12 of the fuel cell 10. The input conduit 14 is configured to allow gas to flow from the chamber 16 to the fuel cell 10 through the input conduit 14. The input conduit 14 can include a hydrophobic segment 15 disposed between the chamber 16 and the fuel cell input port 12, as shown in FIG. 2. The hydrophobic segment 15 may include a hydrophobic coating to prevent water from getting into the fuel cell 10 by virtue of capillary action (i.e., wicking).

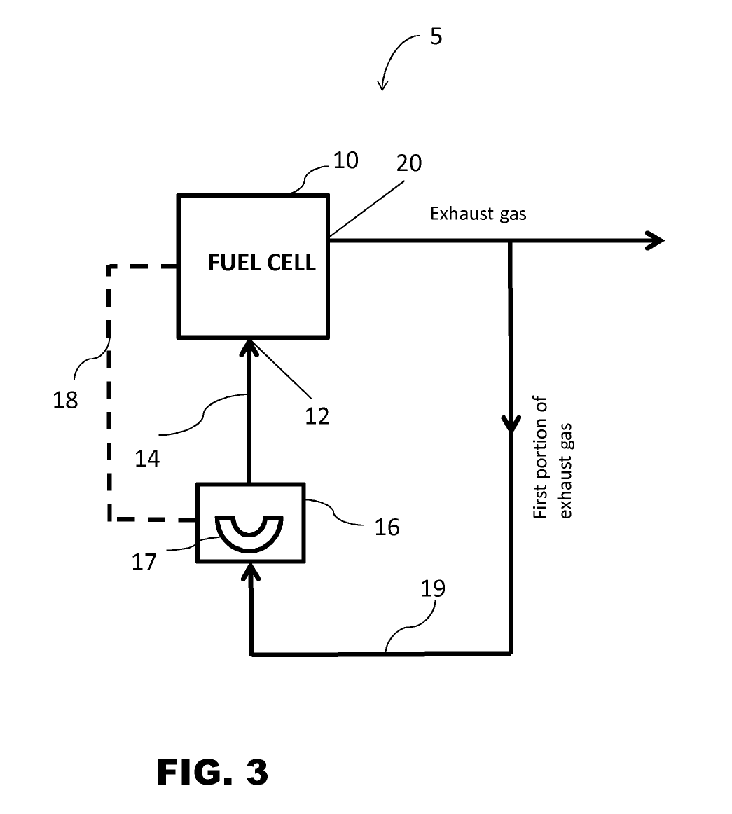

Referring to FIG. 3, in some embodiments, the fuel cell 10 may also include exhaust port 20 configured to allow exhaust gas to flow from the fuel cell 10, and the fuel cell system 5 may further include a recirculation conduit 19 having a first end coupled to the exhaust port 20 and a second end coupled to the liquid water transient accumulation chamber 16. The recirculation conduit 19 is configured to pass a first portion of the exhaust gas to the fuel cell input port 12, and the liquid water transient accumulation chamber 16 is configured to collect condensed water vapor from the first portion of the exhaust gas. Fuel cell performance may be improved by using a portion of the exhaust gas as a portion of the input gas by providing water vapor and carbon dioxide into the fuel cell 10, but the same water vapor which may be desirable for fuel cell performance also increases the risk of condensation and explosive boiling, e.g., during cold transient conditions.

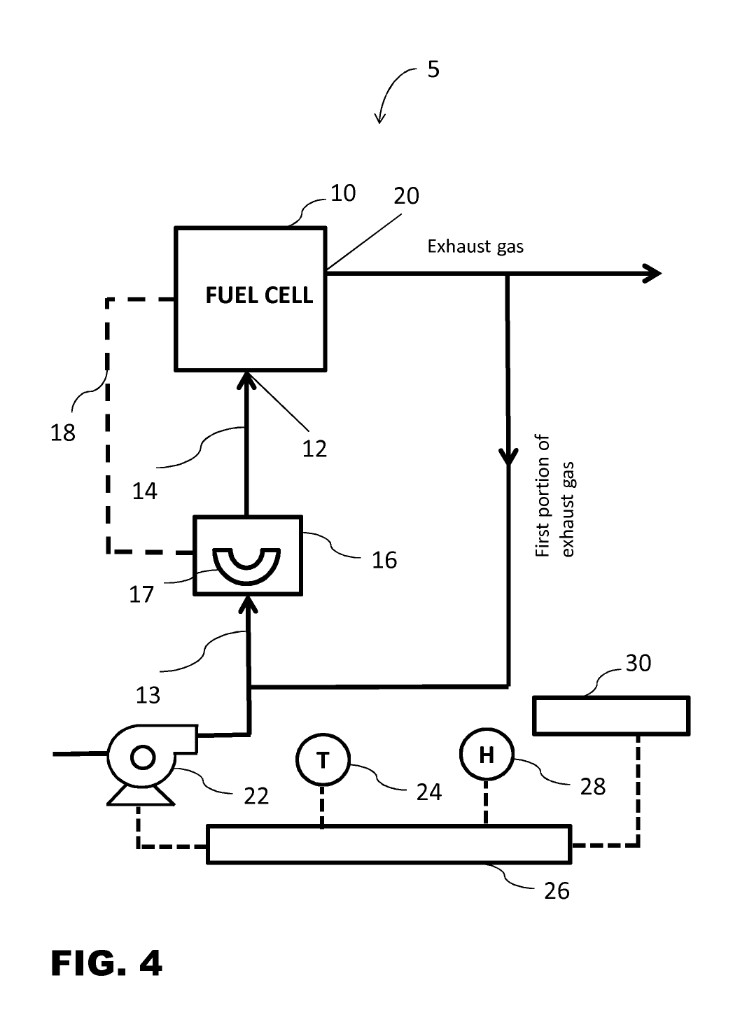

As illustrated in FIG. 4, according to some embodiments of the present invention, the portable fuel cell system 5 may include pump 22 configured to pump gas through the fuel cell 10, temperature sensor 24, and fuel cell system controller 26 coupled to the pump 22 and the temperature sensor 24. The fuel cell system controller 26 is configured to control operation of the pump 22 and prevent its operation when the temperature sensor 24 is below a minimum temperature threshold. In some embodiments, the system 5 may additionally include humidity sensor 28 coupled to the fuel cell system controller 26 and configured to provide a humidity sensor signal to the fuel cell system controller 26 such that the minimum temperature threshold is based on the humidity sensor signal. The system 5 may also include heater 30 coupled to the fuel cell system controller 26. The fuel cell system controller 26 may be further configured to cause the heater 30 to supply heat when the temperature sensor 24 is below the minimum temperature threshold.

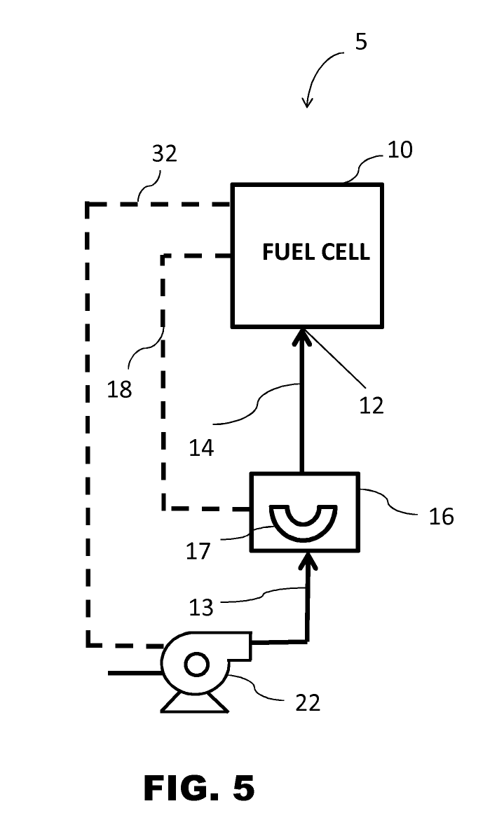

In some embodiments, as shown in FIG. 5, the portable fuel cell system 5 can include pump 22 configured to pump gas through the fuel cell 10 and a second thermal pathway 32 in thermal communication with the pump 22 and in thermal communication with the fuel cell 10. The first thermal pathway 18 and the second thermal pathway 32 can be a component or construction of the system, which encourages heat transfer between objects. For example, heat transfer may be accomplished by direct physical contact, coupling with a thermally conductive body, or conductive and radiative transfer due to proximity. For example, the thermal coupling between the chamber 16 and the fuel cell and/or the pump 22 and the fuel cell 10 can be accomplished by a metal strip, a heat pipe, thermal grease, forced hot air, or physical contact, such as direct physical contact, between the fuel cell 10 and the pump 22 or chamber 16. This thermal coupling allows the transfer of heat generated by the fuel cell 10 to the pump 22 and/or the chamber 16, thereby raising the temperature inside of these structures and hence preventing water from condensing in the pump 22, the chamber 16, and/or the input conduit 14.

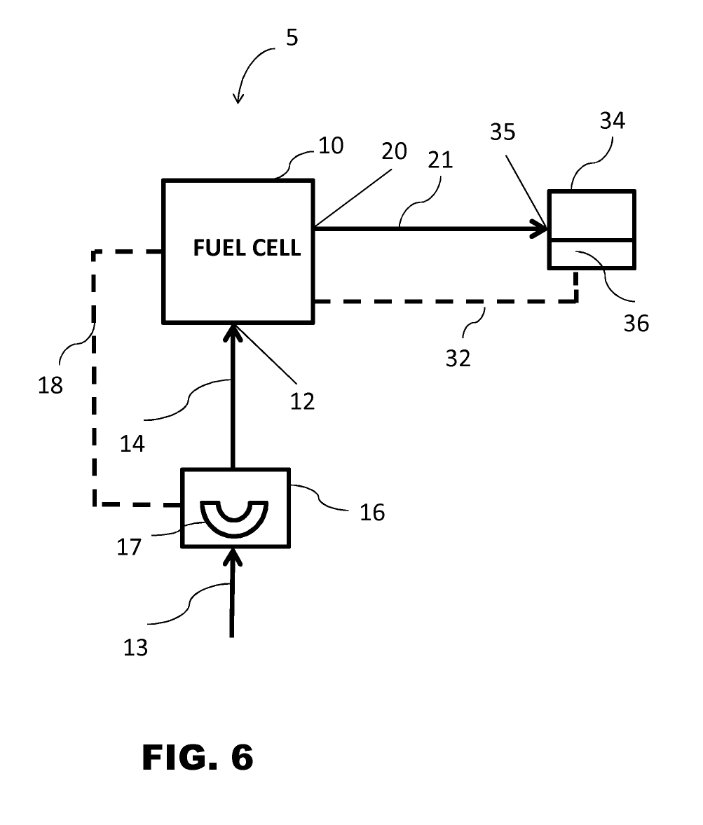

As shown in FIG. 6, the fuel cell 10 may include exhaust port 20 configured to allow exhaust gas to flow from the fuel cell 10, and the fuel cell system 5 may include muffler 34 having muffler inlet 35 and muffler pressure restriction element 36. The system 5 may further include exhaust conduit 21 having a first end coupled to the exhaust port 20 and a second end coupled to the muffler inlet 35, the exhaust conduit 21 configured to allow gas to flow from the fuel cell 10 through the exhaust conduit 21. The system 5 may further include second thermal pathway 32 in thermal communication with the fuel cell 10 and in thermal communication with the muffler pressure restriction element 36. In some embodiments, the muffler pressure restriction element 36 effects the ratio of exhaust gas exiting the system to the exhaust gas recirculated as a portion of the input gas to the fuel cell 10. Additionally, the muffler pressure restriction element 36 can be configured so as to decrease the acoustic energy created by the fuel cell system 5.

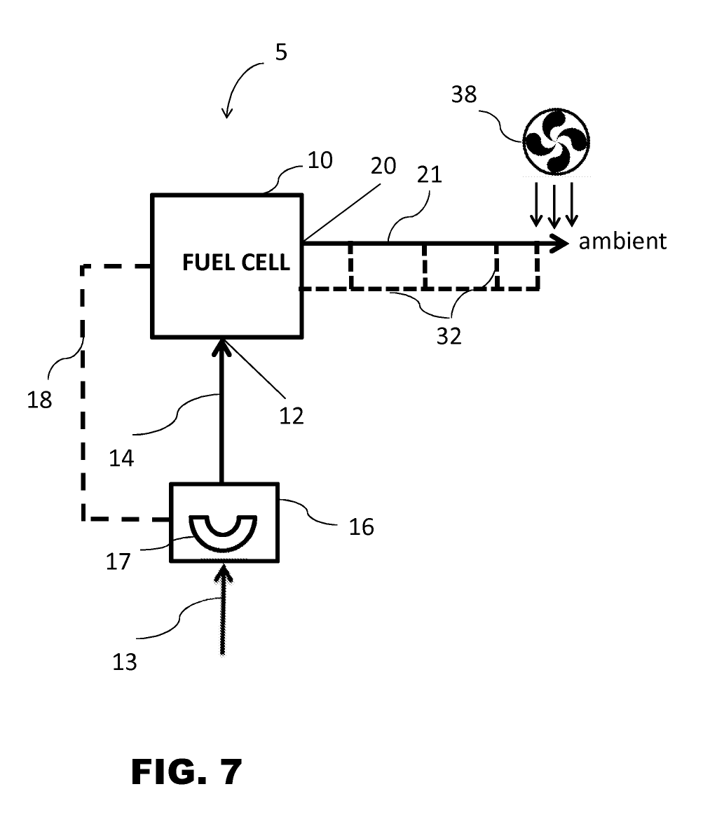

In some embodiments, as illustrated in FIG. 7, the system 5 may include exhaust port 20 configured to allow exhaust gas to flow from the fuel cell 10, and the fuel cell system 5 may further include exhaust conduit 21 having a first end coupled to the exhaust port 20 and a second end coupled to the ambient environment, the exhaust conduit 21 configured to allow gas to flow from the fuel cell 10 through the exhaust conduit 21. The system 5 may further include second thermal pathway 32 in thermal communication with the fuel cell 10 and in thermal communication with the exhaust conduit 21. Preferably, all or substantially all of the exhaust conduit 21 is heated to above about 45 degrees Celsius during steady state operation of the fuel cell system 5. The 45 degrees Celsius temperature is above the dew point for most combustion products of fuel-air mixtures, and therefore helps prevent condensation along the exhaust conduit 21, which is beneficial if a portion of the exhaust gas is used as the input gas, such as shown in FIGS. 3 and 4. The system 5 may also include fan 38 configured to move ambient air across the second end of the exhaust conduit 21.

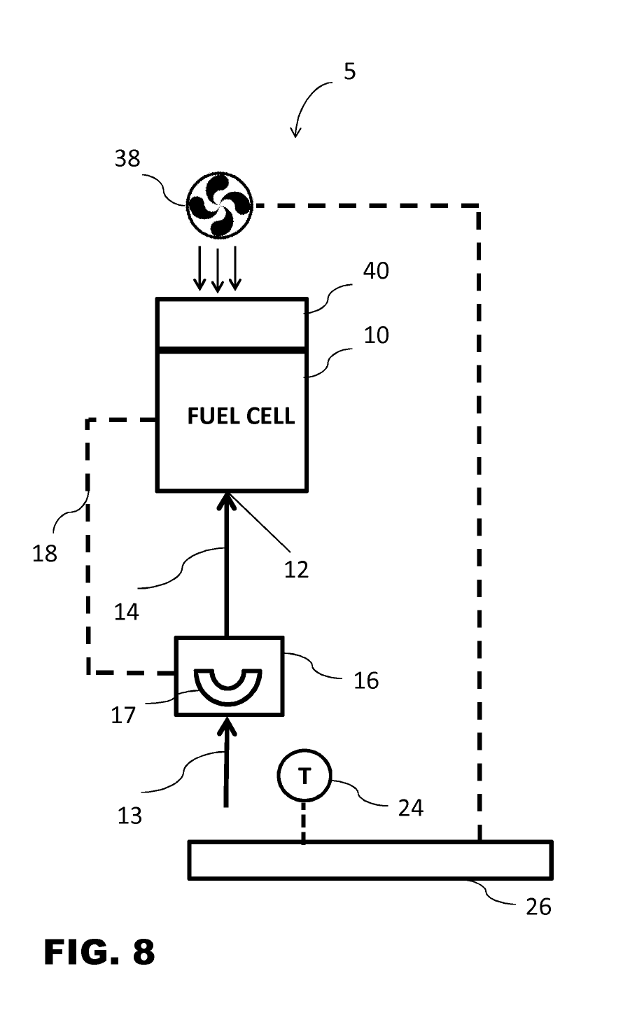

Referring to FIG. 8, according to some embodiments, the system 5 may further include heat sink 40 thermally coupled to the fuel cell 10, fan 38 configured to move ambient air over the heat sink 40, temperature sensor 24, and fuel cell system controller 26 coupled to the fan 38 and the temperature sensor 24. The fuel cell system controller 26 may be configured to control operation of the fan 38 and prevent its operation when the temperature sensor 24 is below a minimum temperature threshold. In some embodiments, the fuel cell system controller 26 may be configured to modulate flow rate of the fan 38 to maintain a target temperature.

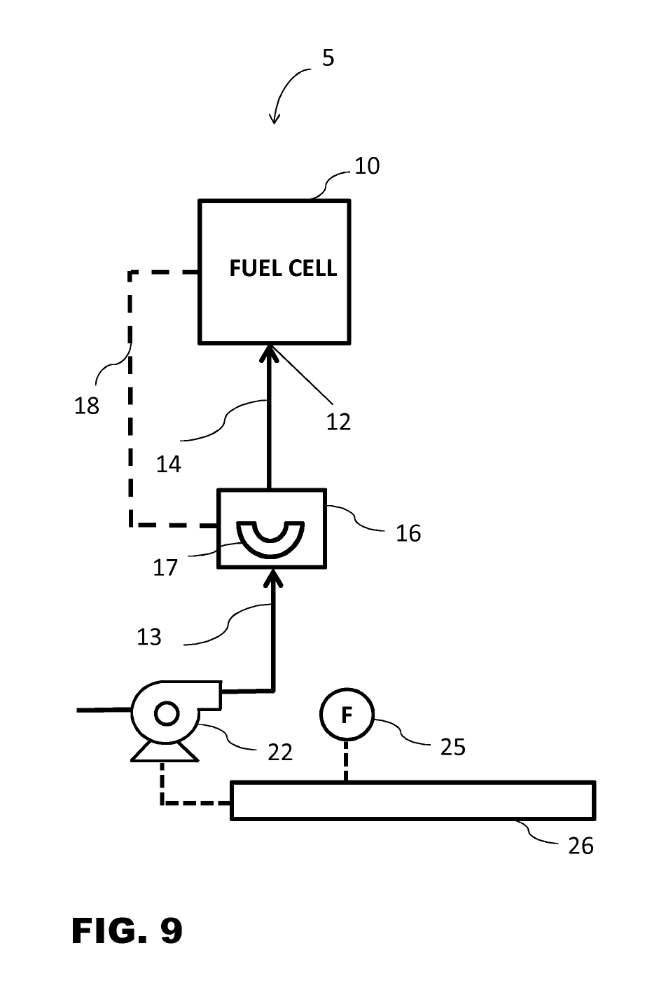

According to some embodiments of the present invention, as illustrated in FIG. 9, the system 5 may further include pump 22 configured to pump gas through the fuel cell 10, fuel cell system controller 26 operationally coupled to the pump 22 and configured to control operation of the pump 22, and fuel flow controller 25 coupled to the fuel cell system controller 26 and configured to control the flow of fuel to the fuel cell 10. The fuel cell system controller 26 is configured to cause the pump 22 to continue pumping after the fuel flow controller 25 has stopped the flow of fuel. Such a configuration contributes to safe and reliable operation of the fuel cell system 5, because it prevents water from being condensed and trapped in the chamber input conduit 13 before reaching the chamber 16 where the water can be collected and evaporated.

The foregoing embodiments of the present invention provide a fuel cell system with protection against damage from liquid water (e.g., transiently formed during startup operation), and therefore result in the system being more reliable than prior art systems.

The embodiments of the invention described above are intended to be merely exemplary; numerous variations and modifications will be apparent to those skilled in the art. All such variations and modifications are intended to be within the scope of the present invention as defined in any appended claims. For example, although some features may be included in some embodiments and drawings and not in others, these features may be combined with any of the other features in accordance with embodiments of the invention as would be readily apparent to those skilled in the art based on the teachings herein.

What is claimed is:

1. A portable fuel cell system having protection from liquid, the system comprising:
a fuel cell having an input port configured to receive an input gas;
a liquid water transient accumulation chamber coupled to the fuel cell input port and configured to accumulate condensed water vapor from the input gas, the chamber including a water-capture element configured to retain liquid water therein; and
a first thermal pathway coupled to the chamber and also coupled to the fuel cell, so that the chamber is heated by heat from the fuel cell, when the fuel cell is operating in a steady state, in a manner that causes the liquid water accumulated in the chamber to be evaporated by the heat.

2. A portable fuel cell system according to claim 1, wherein the fuel cell is configured for use above 100 degrees Celsius.

3. A portable fuel cell system according to claim 1, wherein the fuel cell further comprises an exhaust port configured to provide an exhaust gas flow, and the system further comprises:
a recirculation conduit having a first end coupled to the exhaust port and a second end coupled to the liquid water transient accumulation chamber, wherein the recirculation conduit is configured to pass a first portion of the exhaust gas to the fuel cell input port, and the liquid water transient accumulation chamber is configured to condense water vapor from the first portion of the exhaust gas.

4. A portable fuel cell system according to claim 1, the system further comprising:
a pump configured to pump gas through the fuel cell;
a temperature sensor; and
a fuel cell system controller coupled to the pump and the temperature sensor, wherein the fuel cell system controller is configured to prevent operation of the pump when the temperature sensor is below a minimum temperature threshold.

5. A portable fuel cell system according to claim 4, the system further comprising a humidity sensor coupled to the fuel cell system controller and configured to provide a humidity sensor signal to the fuel cell system controller, wherein the minimum temperature threshold is based on the humidity sensor signal.

6. A portable fuel cell system according to claim 4, the system further comprising a heater coupled to the fuel cell system controller, wherein the fuel cell system controller is further configured to cause the heater to supply heat when the temperature sensor is below the minimum temperature threshold.

7. A portable fuel cell system according to claim 1, the system further comprising:
a pump configured to pump gas through the fuel cell; and
a second thermal pathway in thermal communication with the pump and in thermal communication with the fuel cell.

8. A portable fuel cell system according to claim 1, wherein the fuel cell further comprises an exhaust port configured to provide an exhaust gas flow, and the system further comprises:
a muffler having a muffler inlet and a muffler pressure restriction element;
an exhaust conduit having a first end coupled to the exhaust port and a second end coupled to the muffler inlet; and
a second thermal pathway in thermal communication with the fuel cell and in thermal communication with the muffler pressure restriction element.

9. A portable fuel cell system according to claim 1, wherein the fuel cell further comprises an exhaust port configured to provide an exhaust gas flow, and the system further comprises:
an exhaust conduit having a first end coupled to the exhaust port and a second end coupled to ambient environment, and
a second thermal pathway in thermal communication with the fuel cell and in thermal communication with the exhaust conduit configured so that substantially all of the exhaust conduit is above 45 degrees Celsius during steady state operation of the fuel cell system.

10. A portable fuel cell system according to claim 9, the system further comprising a fan configured to move ambient air across the second end of the exhaust conduit.

11. A portable fuel cell system according to claim 1, the system further comprising:
a heat sink thermally coupled to the fuel cell;
a fan configured to move ambient air over the heat sink;
a temperature sensor; and
a fuel cell system controller coupled to the fan and the temperature sensor, wherein the fuel cell system controller is configured to prevent operation of the fan when the temperature sensor is below a minimum temperature threshold.

12. A portable fuel cell system according to claim 1, the system further comprising:
a heat sink thermally coupled to the fuel cell;
a fan configured to move ambient air over the heat sink at a fan flow rate;
a temperature sensor; and
a fuel cell system controller coupled to the fan and the temperature sensor, wherein the fuel cell system controller is configured to modulate the fan flow rate to maintain a target temperature.

13. A portable fuel cell system according to claim 1, the system further comprising:
a pump configured to pump gas through the chamber;
a fuel cell system controller operationally coupled to the pump and configured to control operation of the pump; and
a fuel flow controller coupled to the fuel cell system controller, the fuel flow controller configured to stop flow of fuel to the fuel cell, wherein the fuel cell system controller is further configured to cause the pump to continue pumping after the fuel flow controller has stopped the flow of fuel.

14. A portable fuel cell system according to claim 1, wherein the fuel cell is a solid oxide fuel cell.

15. A portable fuel cell system according to claim 1, the system further comprising:
an input conduit with a first end coupled to the liquid water transient accumulation chamber and a second end coupled to the input port, the input conduit having a hydrophobic segment, the hydrophobic segment having a hydrophobic coating.
